(19) United States
(12) Patent Application Publication
(10) Pub. No.: US 2024/0403120 A1
(43) Pub. Date: Dec. 5, 2024

(54) RESOURCE MANAGEMENT SYSTEMS AND METHODS THEREOF

(71) Applicant: ZHEJIANG DAHUA TECHNOLOGY CO., LTD., Hangzhou (CN)

(72) Inventors: Chao LIU, Hangzhou (CN); Wei GAO, Hangzhou (CN); Chao HAN, Hangzhou (CN); Mingwei ZHOU, Hangzhou (CN)

(73) Assignee: ZHEJIANG DAHUA TECHNOLOGY CO., LTD., Hangzhou (CN)

(21) Appl. No.: 18/783,372

(22) Filed: Jul. 24, 2024

Related U.S. Application Data
(63) Continuation of application No. PCT/CN2022/142676, filed on Dec. 28, 2022.

(30) Foreign Application Priority Data
Jan. 25, 2022 (CN) 202210086577.3

(51) Int. Cl. G06F 9/50; G06F 9/48

(52) U.S. Cl. CPC G06F 9/5016; G06F 9/4881

(57) ABSTRACT

The present disclosure provides resource management systems and methods thereof. The resource management systems may include a plurality of worker nodes and a master node communicatively connected to the plurality of worker nodes. Each of one or more candidate worker nodes of the plurality of worker nodes may include both computing resources and storage resources. The master node may include a first scheduler and a second scheduler. The first scheduler may be configured to allocate at least part of the computing resources of the one or more candidate worker nodes for a scheduling task, and the second scheduler may be configured to schedule at least part of the storage resources of the one or more candidate worker nodes for the scheduling task.

### CROSS-REFERENCE TO RELATED APPLICATIONS

This application is a Continuation of International Application No. PCT/CN2022/142676 filed on Dec. 28, 2022, which claims priority of Chinese Patent Application No. 202210086577.3 filed on Jan. 25, 2022, the contents of which are hereby incorporated by reference.

### TECHNICAL FIELD

The present disclosure generally relates to cloud platform techniques, and more particularly, relates to resource management systems and methods thereof.

### BACKGROUND

With the rise of container techniques, a plurality of resource management systems (e.g., a Kubernetes cluster, Docker Swarm, Mesosphere, etc.) have been developed and used in cloud platform techniques. The Kubernetes cluster has become a leader in the container techniques due to management capabilities and intelligent scheduling algorithms of the Kubernetes cluster.

The Kubernetes cluster includes a master node and a plurality of worker nodes. A scheduler in the master node is mainly used to reasonably allocate resources of the plurality of worker nodes and schedule applications to appropriate worker nodes. However, the scheduler only allocates and schedules a portion of the resources, such as, a central processing unit (CPU), a memory, a graphics processing unit (GPU), etc., of a worker node. Partial storage resources (e.g., a local disk) of the worker node cannot be allocated or scheduled. Therefore, it is desirable to provide systems and methods for resource management, specifically systems and methods for storage resource management, in order to allocate and/or schedule the storage resources.

### SUMMARY

In an aspect of the present disclosure, a resource management system is provided. The resource management system may include a plurality of worker nodes and a master node communicatively connected to the plurality of worker nodes. Each of one or more candidate worker nodes of the plurality of worker nodes may include both computing resources and storage resources. The master node may include a first scheduler and a second scheduler. The first scheduler may be configured to allocate at least part of the computing resources of the one or more candidate worker nodes for a scheduling task, and the second scheduler may be configured to schedule at least part of the storage resources of the one or more candidate worker nodes for the scheduling task.

In another aspect of the present disclosure, a method is provided. The method may be implemented on a resource management system having at least one processor and at least one storage device. The resource management system may include a plurality of worker nodes and a master node communicatively connected to the plurality of worker nodes. Each of one or more candidate worker nodes of the plurality of worker nodes may include both computing resources and storage resources. The master node may include a first scheduler and a second scheduler. The method may include allocating at least part of the computing resources of the one or more candidate worker nodes for a scheduling task; and scheduling at least part of the storage resources of the one or more candidate worker nodes for the scheduling task.

In a further aspect of the present disclosure, a non-transitory computer readable medium is provided. The non-transitory computer readable medium may be in a resource management system. The resource management system may include a plurality of worker nodes and a master node communicatively connected to the plurality of worker nodes. Each of one or more candidate worker nodes of the plurality of worker nodes may include both computing resources and storage resources. The master node may include a first scheduler and a second scheduler. The non-transitory computer readable medium may include executable instructions that, when executed by at least one processor, direct the at least one processor to perform a method. The method may include allocating at least part of the computing resources of the one or more candidate worker nodes for a scheduling task; and scheduling at least part of the storage resources of the one or more candidate worker nodes for the scheduling task.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary resource management system according to some embodiments of the present disclosure;

FIG. 2 is a schematic diagram illustrating exemplary resource management system according to some embodiments of the present disclosure;

FIG. 3 is a block diagram illustrating an exemplary second scheduler according to some embodiments of the present disclosure;

FIG. 4 is a flowchart illustrating an exemplary process for scheduling at least part of storage resources of one or more worker nodes for a scheduling task according to some embodiments of the present disclosure;

FIG. 5 is a flowchart illustrating an exemplary process for storing storage planning information in an annotation of a candidate worker node according to some embodiments of the present disclosure;

FIG. 6 is a flowchart illustrating another exemplary process for establishing a persistent volume (PV) for a scheduling task according to some embodiments of the present disclosure; and

FIG. 7 is a schematic diagram illustrating an exemplary electronic device for resource management according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

A resource management system of a cloud platform can be used to manage computing resources (e.g., central processing units (CPUs), memories, graphics processing units (GPUs), etc.) to allocate the computing resources and perform scheduling tasks. Kubernetes cluster is a leading resource management system for cloud platforms. However, for a scheduling task that needs a storage resource, the Kubernetes cluster is unable to reasonably allocate and schedule storage resources to perform the scheduling task. Therefore, a resource management system that can schedule storage resources needs to be provided for cloud platforms.

The present disclosure relates to resource management systems and methods thereof. The resource management system may include a plurality of worker nodes and a master node, wherein each of one or more candidate worker nodes of the plurality of worker nodes includes both computing resources and storage resources. The master node may be communicatively connected to the plurality of worker nodes. In some embodiments, the master node may include a first scheduler and a second scheduler. The first scheduler may be configured to allocate at least part of the computing resources of the one or more candidate worker nodes for a scheduling task, and the second scheduler may be configured to schedule at least part of the storage resources of the one or more candidate worker nodes for the scheduling task. By introducing the second scheduler, the storage resources can be scheduled for the scheduling task, which can improve management capability of the resource management system.

Further, the resource management system may generate a scheduling record recording that the at least part of the storage resources are scheduled for the scheduling task, which can ensure a consistency between a scheduling operation for the scheduling task and a storage operation for the scheduling task, thereby improving the accuracy of the resource management.

In addition, the resource management system may generate the storage planning information relating to the storage resources, which can plan the usage of the storage resources according to the preference of the user, thereby improving the accuracy of subsequent scheduling of storage resources based on the storage planning information.

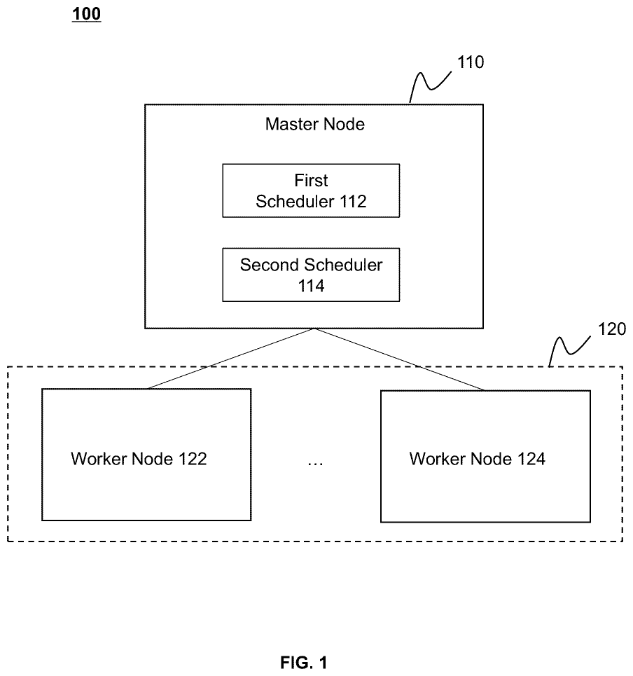

FIG. 1 is a schematic diagram illustrating an exemplary resource management system 100 according to some embodiments of the present disclosure.

In some embodiments, the resource management system 100 may be configured to automatically manage resources in the resource management system 100 and/or resources connected to the resource management system 100. The resources may include computing resources and/or storage resources. In some embodiments, the computing resources may include a central processing unit (CPU), a memory, a graphics processing unit (GPU), etc. The storage resources may include a local disk, such as, a hard disk drive (HHD) storage resource, a solid state drive (SSD) storage resource, etc. For illustration purposes, the resource management system 100 may be a Kubernetes (also referred to as K8s) cluster. The Kubernetes cluster may be an open-source platform for automatic deployment, expansion, and management of resources. The Kubernetes cluster may manage its computing resources and storage resources based on a claim of a user. It should be noted that the Kubernetes cluster is merely provided for illustration, and is not intended to limit the scope of the present disclosure. The resource management system 100 may be any management system that is capable to manage resources, such as, the Docker Swarm, the Mesosphere, etc.

As shown in FIG. 1, the resource management system 100 may include a master node 110 and a plurality of worker nodes 120. The plurality of worker nodes 120 may a worker node 122, a worker node 124, etc.

In some embodiments, the resource management system 100 may have a distributed architecture (or a primary/replica architecture). For example, as shown in FIG. 1, the master node 110 may be communicatively connected to the worker node 122, the worker node 124, etc., respectively. As used herein, the master node 110 may control the worker node 122, the worker node 124, etc., and serve as a communication hub of the worker node 122, the worker node 124, etc.

The master node 110 may refer to a control node of the resource management system 100. In some embodiments, the master node 110 may be configured to manage the resource management system 100. For example, the master node 110 may allocate and/or schedule resources (e.g., computing resources and/or storage resources) in the plurality of worker nodes 120 for a scheduling task. The scheduling task may refer to a task that needs to be implemented using computing resources and/or storage resources. For example, the scheduling task may relate to one or more applications that need to be run, and the running of the application(s) requires computing resources and/or storage resources.

In some embodiments, the master node 110 may include a first scheduler 112 and a second scheduler 114. The first scheduler 112 may be configured to allocate at least part of the computing resources in the plurality of worker nodes 120 for the scheduling task. The second scheduler 114 may be configured to schedule at least part of the storage resources in the plurality of worker nodes 120 for the scheduling task.

The plurality of worker nodes 120 (e.g., the worker node 122, the worker node 124, etc.) may be configured to execute the scheduling task (e.g., run the application(s) corresponding to the scheduling task). For example, after the master node 110 allocates and/or schedules at least part of resources in the plurality of worker nodes 120 for the scheduling task, one or more worker nodes corresponding to the at least part of resources may be used to run the application(s) corresponding to the scheduling task. Merely by way of example, when the master node 110 schedules at least part of storage resources of the worker node 122 for the scheduling task, the application(s) corresponding to the scheduling task may be run on the worker node 122 (e.g., the at least part of storage resources of the worker node 122), and the scheduled storage resources may be used in the running of the application(s).

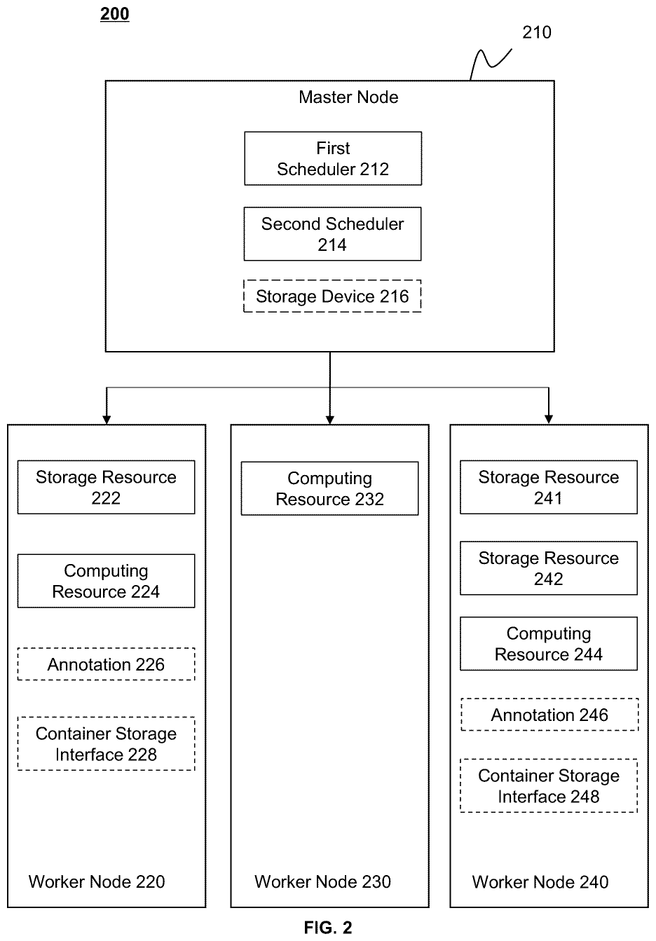

In some embodiments, the master node 110 and the plurality of worker nodes 120 may form the Kubernetes cluster. More descriptions a structure of the resource management system may be found elsewhere in the present disclosure (e.g., FIG. 2 and the descriptions thereof).

It should be noted that the resource management system 100 is provided for illustration purposes, and is not intended to limit the scope of the present disclosure. For persons having ordinary skills in the art, multiple variations and modifications may be made under the teachings of the present disclosure. However, those variations and modifications do not depart from the scope of the present disclosure. For example, the resource management system 100 may include a plurality of master nodes, and each of the plurality of master nodes may be communicatively connected to a plurality of worker nodes, respectively.

FIG. 2 is a schematic diagram illustrating exemplary resource management system according to some embodiments of the present disclosure. A resource management system 200 may be an embodiment of the resource management system 100 described in FIG. 1.

As shown in FIG. 2, the resource management system 200 may include a master node 210 and a plurality of worker nodes (e.g., a worker node 220, a worker node 230, and a worker node 240).

In some embodiments, the master node 210 may be communicatively connected to the plurality of worker nodes. For example, as shown in FIG. 2, the master node 210 may be communicatively connected to the worker node 220, the worker node 230, and the worker node 240, respectively.

In some embodiments, the master node 210 may be configured to manage the resource management system 200. For example, the master node 210 may allocate and/or schedule resources (e.g., computing resources and/or storage resources) in the resource management system 200 and/or resources connected to the resource management system 200 for a scheduling task. As another example, the master node 210 may allocate and/or schedule the resources to meet different workloads.

In some embodiments, the resources to be allocated and/or scheduled may include computing resources and/or storage resources. In some embodiments, each of the plurality of worker nodes may include computing resources. Optionally, one or more of the worker nodes may include storage resources. For example, as shown in FIG. 2, the worker node 220 may include storage resource 222 and computing resource 224, the worker node 230 may include computing resource 232, and the worker node 240 may include storage resource 241, storage resource 242, and computing resource 242.

In some embodiments, the master node 210 may include a first scheduler 212 and a second scheduler 214. A scheduler (e.g., the first scheduler 212 or the second scheduler 214) may be configured to allocate and/or schedule resources in the resource management system 200. Merely by way of example, the first scheduler 212 may be configured to allocate at least part of computing resources in the resource management system 200, and the second scheduler 214 may be configured to schedule at least part of storage resources in the resource management system 200. For example, the first scheduler 212 may allocate at least one of the computing resource 224, the computing resource 232, or the computing resource 242 for a scheduling task. As another example, the second scheduler 214 may schedule at least one of the storage resource 222, the storage resource 241, or the storage resource 242, for the scheduling task.

In some embodiments, the first scheduler 212 may refer to an original scheduler of the resource management system 200. For example, the first scheduler 212 may be designed based on source codes of the resource management system 200. The second scheduler 214 may refer to an extensible scheduler of the resource management system 200. For example, the second scheduler 214 may be designed by extending the source codes of the resource management system 200. As another example, the second scheduler 214 may be designed through a plug-in. Merely by way of example, the second scheduler 214 may be embedded in the first scheduler 212 using a plug-in.

In some embodiments, the master node 210 may be connected to or include a processing device. Therefore, the master node 210 (e.g., the first scheduler 212 and the second scheduler 214) may process data and/or information through the processing device. For example, the master node 210 (e.g., the first scheduler 212 and the second scheduler 214) may allocate and/or schedule the resources through the processing device. In some embodiments, the processing device may be a single server or a server group. The server group may be centralized or distributed. In some embodiments, the processing device may be local or remote. In some embodiments, the processing device may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the processing device may be implemented by a computing device. For example, the computing device may include a processor, a storage, an input/output (I/O), and a communication port. The processor may execute computer instructions (e.g., program codes) and perform functions of the processing device in accordance with the techniques described herein. The computer instructions may include, for example, routines, programs, objects, components, data structures, procedures, modules, and functions, which perform particular functions described herein.

In some embodiments, the master node 210 may further include a storage device 216. The storage device 216 may store data/information obtained from the first scheduler 212, the second scheduler 214, the plurality of worker nodes, and/or any other components of the resource management system 200. For example, when one worker node (e.g., the worker node 220, the worker node 230, and the worker node 240) processes the scheduling task, a scheduling record may be generated and stored in the storage device 216. As another example, the second scheduler 214 may remove the scheduling record from the storage device 216.

In some embodiments, the storage device 216 may store a custom resource definition (CRD) file, which is configured to manage custom resource(s) (e.g., the storage resources). For example, when a storage resource is scheduled, a corresponding scheduling record may be stored in the CRD file. In some embodiments, the storage device 216 may include an etcd component, which is an open-source, and distributed component for storing key-value pair data. The etcd component may be configured to store data of the resource management system 200. For example, the scheduling record may be stored in the etcd component. In some embodiments, the storage device 216 may include a mass storage, a removable storage, a volatile read-and-write memory, a read-only memory (ROM), or the like, or any combination thereof. For example, the mass storage may include a magnetic disk, an optical disk, a solid-state drive, etc. The removable storage may include a flash drive, a floppy disk, an optical disk, a memory card, a zip disk, a magnetic tape, etc. In some embodiments, the storage device 216 may store one or more programs and/or instructions for a processing device to execute to perform exemplary methods described in the present disclosure.

In some embodiments, the storage device 216 may be communicated with one or more other components (e.g., the plurality of worker nodes) in the resource management system 200. One or more components in the resource management system 200 may access the data or instructions stored in the storage device 216. In some embodiments, the storage device 216 may be part of the processing device.

In some embodiments, one or more Pods may be used in the resource management system 200 to load computing resources and/or storage resources. Each Pod may include one or more containers (e.g., Docker container) and the container(s) may share the computing resources and/or the storage resources of the Pod. In some embodiments, the master node 210 may allocate and/or schedule at least part of the resources in the resource management system 200 by allocating and/or scheduling a pod including the at least part of the resources. For illustration purposes, in the present disclosure, “allocating and/or scheduling a pod including the at least part of the resources” may be referred to as “allocating and/or scheduling the at least part of the resources” for brevity.

In some embodiments, the plurality of worker nodes (e.g., the worker node 220, the worker node 230, and the worker node 240) may be configured to implement the scheduling task. For example, after the master node 210 allocates and/or schedules at least part of resources (e.g., computing resources and/or storage resources) for the scheduling task, one or more worker nodes corresponding to the at least part of resources may implement the scheduling task (e.g., be used to run the application(s) corresponding to the scheduling task). As another example, when the master node 210 schedules the storage resource 241 of the worker node 240 for the scheduling task, application(s) corresponding to the scheduling task may be run on the worker node 240 (e.g., the storage resource 241 of the worker node 240), and the scheduled storage resource 241 may be used in the running of the application(s).

In some embodiments, a worker node may be connected to or integrated in the processing device of the master node 210.

In some embodiments, the running of the application(s) corresponding to the scheduling task may need storage resources. To facilitate storage resource scheduling, a worker node including both computing resources and storage resources may be predetermined as a candidate worker node. Optionally, a storage planning instruction may be input by a user to set the uses of the worker node.

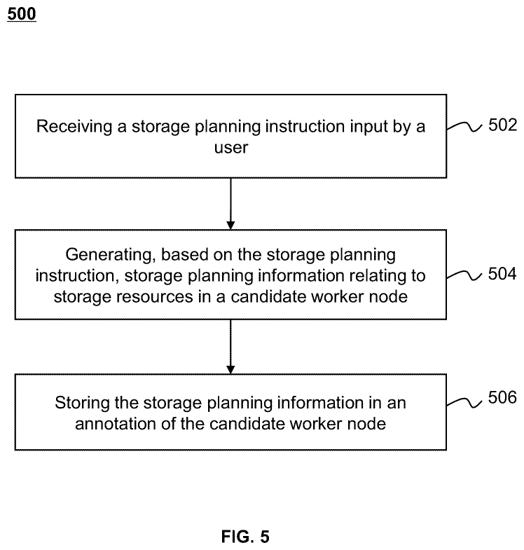

Merely by way of example, as shown in FIG. 2, since the worker node 220 includes the storage resource 222 and the computing resource 224, the worker node 230 includes the computing resource 232, and the worker node 240 includes the storage resource 241, the storage resource 242, and the computing resource 242, the worker node 220 and the worker node 240 may be determined as candidate worker nodes. Accordingly, storage planning information relating to the storage resources in each candidate worker node (e.g., the worker node 220 and the worker node 240) may be generated based on the corresponding storage planning instruction and stored in an annotation of the candidate worker node. That is, storage planning information relating to the storage resource 222 in the worker node 220 may be generated based on a storage planning instruction corresponding to the worker node 220 and stored in an annotation 226 of the worker node 220, and storage planning information relating to the storage resources 241 and 242 in the worker node 240 may be generated based on a storage planning instruction corresponding to the worker node 240 and stored in an annotation 246 of the worker node 240. More descriptions regarding the generation and/or storage of the storage planning information may be found elsewhere in the present disclosure (e.g., FIG. 5 and the descriptions thereof).

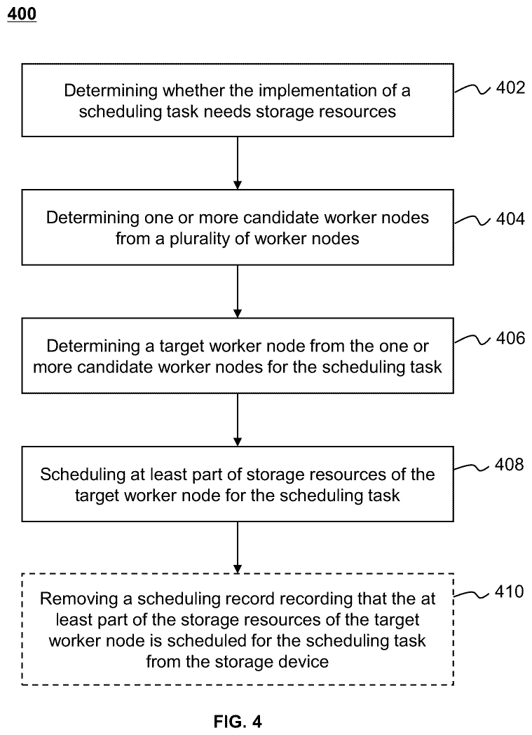

Further, the first scheduler 212 may allocate at least part of computing resources of the candidate worker nodes (e.g., the worker node 220 and the worker node 240) for the scheduling task, and the second scheduler 214 may schedule at least part of storage resources of the candidate worker nodes (e.g., the worker node 220 and the worker node 240) for the scheduling task. More descriptions regarding the allocation of the computing resources and/or the scheduling of the storage resources may be found elsewhere in the present disclosure (e.g., FIGS. 4-6 and the descriptions thereof).

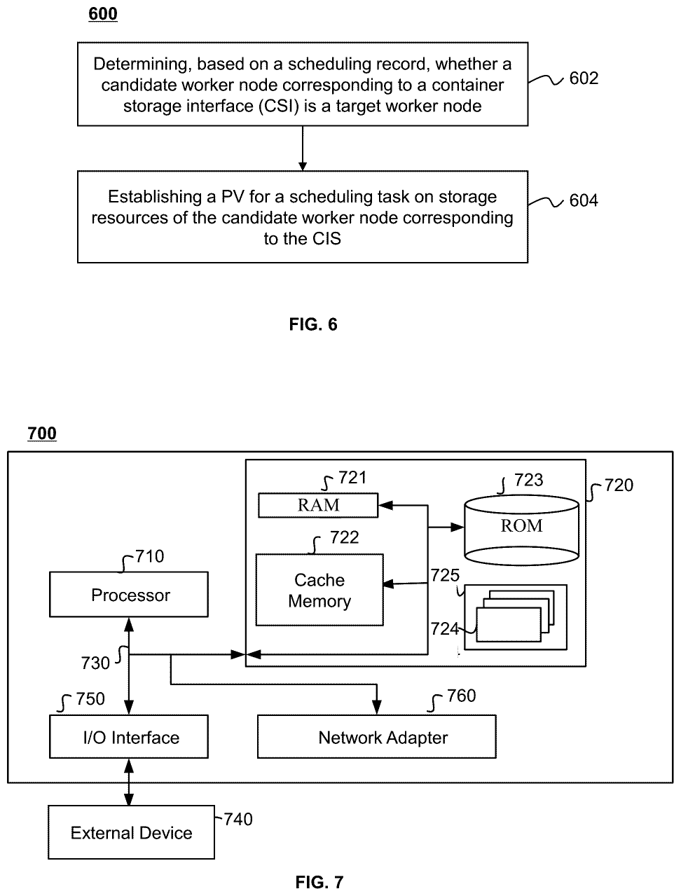

In some embodiments, each of the one or more candidate worker nodes may include a container storage interface (CSI). For example, the worker node 220 may include a CIS 228, and the worker node 240 may include a CIS 248. The CSI of a candidate worker node may be configured to establish a persistent volume (PV) for a scheduling task on the storage resources of the candidate worker node. For example, if a candidate worker node corresponding to the CIS is determined as a target worker node (e.g., a worker node for running an application corresponding to the scheduling task), a PV for the scheduling task may be established on the storage resources of the candidate worker node corresponding to the CIS. Merely by way of example, if the worker node 220 is determined as the target worker node, the CIS 228 may establish a PV for the scheduling task on the storage resource 222 of the candidate worker node 220. As another example, if the worker node 240 is determined as the target worker node, the CIS 248 may establish a PV for the scheduling task on the storage resource 241 and/or the storage resource 242 of the candidate worker node 240. More descriptions regarding the establishment of the PV may be found elsewhere in the present disclosure (e.g., FIG. 6 and the descriptions thereof).

In some embodiments, the resource management system 200 may further include a network and/or at least one terminal. The network may facilitate the exchange of information and/or data for the resource management system 200. In some embodiments, one or more components (e.g., the master node 210, the plurality of worker nodes) of the resource management system 200 may transmit information and/or data to other component(s) of the resource management system 200 via the network. In some embodiments, the network may be any type of wired or wireless network, or a combination thereof.

The at least one terminal may be configured to receive information and/or data from the master node 210 and/or the plurality of worker nodes, such as, via the network. In some embodiments, the at least one terminal may process information and/or data received from the master node 210 and/or the plurality of worker nodes. In some embodiments, the at least one terminal may enable a user interface via which a user may view information and/or input data and/or instructions to the resource management system 200. In some embodiments, the at least one terminal may include a mobile phone, a computer, a wearable device, or the like, or any combination thereof. In some embodiments, the at least one terminal may include a display that can display information in a human-readable form, such as text, image, audio, video, graph, animation, or the like, or any combination thereof. The display of the at least one terminal may include a cathode ray tube (CRT) display, a liquid crystal display (LCD), a light-emitting diode (LED) display, a plasma display panel (PDP), a three-dimensional (3D) display, or the like, or a combination thereof.

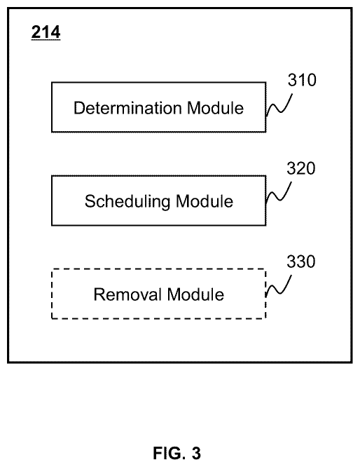

FIG. 3 is a block diagram illustrating an exemplary second scheduler 214 according to some embodiments of the present disclosure. In some embodiments, the modules illustrated in FIG. 3 may be implemented on the second scheduler 214. In some embodiments, the second scheduler 214 may be in communication with a computer-readable storage medium (e.g., the storage device 216 illustrated in FIG. 2) and may execute instructions stored in the computer-readable storage medium. The second scheduler 214 may include a determination module 310, a scheduling module 320, and a removal module 330.

The determination module 310 may be configured to determine whether the implementation of a scheduling task needs storage resources. If the implementation of the scheduling task needs the storage resources, the determination module 310 may determine one or more candidate worker nodes from a plurality of worker nodes, and determine a target worker node from the one or more candidate worker nodes for the scheduling task. More descriptions regarding the determination of the target worker node may be found elsewhere in the present disclosure. See, e.g., operations 302-306 and relevant descriptions thereof.

The scheduling module 320 may be configured to schedule at least part of the storage resources of the target worker node for the scheduling task. More descriptions regarding the scheduling of the at least part of the storage resources may be found elsewhere in the present disclosure. See, e.g., operation 308 and relevant descriptions thereof.

The removal module 330 may be configured to remove, from a storage device, a scheduling record recording that the at least part of the storage resources of the target worker node is scheduled for the scheduling task. More descriptions regarding the removal of the scheduling record may be found elsewhere in the present disclosure. See, e.g., operation 310 and relevant descriptions thereof.

It should be noted that the above descriptions of the second scheduler 214 are provided for the purposes of illustration, and are not intended to limit the scope of the present disclosure. For persons having ordinary skills in the art, various variations and modifications may be conducted under the guidance of the present disclosure. However, those variations and modifications do not depart from the scope of the present disclosure. In some embodiments, the second scheduler 214 may include one or more other modules. For example, the second scheduler 214 may include a storage module to store data generated by the modules in the second scheduler 214. In some embodiments, any two of the modules may be combined as a single module, and any one of the modules may be divided into two or more units.

FIG. 4 is a flowchart illustrating an exemplary process 400 for scheduling at least part of storage resources of one or more worker nodes for a scheduling task according to some embodiments of the present disclosure. In some embodiments, the process 400 may be implemented in the resource management system 200 illustrated in FIG. 2. For example, the process 400 may be stored in a storage device (e.g., the storage device 216, an external storage device) in the form of instructions (e.g., an application), and invoked and/or executed by the second scheduler 214. The operations of the process 400 presented below are intended to be illustrative. In some embodiments, the process 400 may be accomplished with one or more additional operations not described, and/or without one or more of the operations discussed. Additionally, the order in which the operations of the process 400 as illustrated in FIG. 4 and described is not intended to be limiting.

In 402, the second scheduler 214 (e.g., the determination module 310) may determine whether the implementation of a scheduling task needs storage resources.

The scheduling task may refer to a task that needs to be implemented using resources in a resource management system (e.g., the resource management system 200). For example, the scheduling task may include computing data and/or information, storing the data and/or information, or the like, or any combination thereof. As another example, the scheduling task may relate to one or more applications that need to be run, and the running of the application(s) requires computing resources and/or storage resources.

In some embodiments, the scheduling task may relate to one or more applications that need to be run, and the second scheduler 214 may determine whether the implementation of the scheduling task needs storage resources based on the type of the application(s). For example, the running of applications having frequent input/output operations (e.g., frequently access databases like etcd and MySQL) may need local disks (e.g., solid state drive), and the second scheduler 214 may determine that the implementation of such applications needs storage resources.

In some embodiments, the second scheduler 214 may determine whether the implementation of the scheduling task needs storage resources by determining whether the scheduling task satisfied a condition. The condition may relate to, for example, a storage parameter, an importance degree, etc. The storage parameter may indicate whether the implementation of the scheduling task needs storage resources. As another example, the second scheduler 214 may determine an importance degree corresponding to the scheduling task, and determine whether the implementation of the scheduling task needs storage resources based on the importance degree. The importance degree may be set manually by a user or determined based on parameters (e.g., a task type, a task precedence, a task admin, etc.) of the scheduling task. If the importance degree corresponding to the scheduling task exceeds an importance threshold, the second scheduler 214 may determine that the implementation of the scheduling task needs storage resources. The importance threshold may be determined based on the system default setting or set manually by the user.

If the implementation of the scheduling task needs no storage resources, the second scheduler 214 may end the process 400 or implement the scheduling task based on an allocation result determined by a first scheduler (e.g., the first scheduler 212). In some embodiments, the first scheduler 212 may allocate at least part of computing resources in the resource management system for the scheduling task before the process 400. For example, when the implementation of the scheduling task needs no storage resources, the second scheduler 214 may end the process 400 or implement the scheduling task based on the allocation result determined by the first scheduler 212. That is, the at least part of computing resources in the resource management system allocated by the first scheduler 212 may be used to implement the scheduling task.

If the implementation of the scheduling task needs the storage resources, the process 400 may proceed to operation 404.

In 404, the second scheduler 214 (e.g., the determination module 310) may determine one or more candidate worker nodes from a plurality of worker nodes.

A candidate worker node may refer to a worker node including both computing resources and storage resources. For example, referring to FIG. 2, the second scheduler 214 may determine the worker node 220 and the worker node 240 as the one or more candidate worker nodes from the plurality of worker nodes (e.g., the worker node 220, the worker node 230, and the worker node 240).

In 406, the second scheduler 214 (e.g., the determination module 310) may determine a target worker node from the one or more candidate worker nodes for the scheduling task.

The target worker node may refer to a worker node that is determined to implement the scheduling task. For example, the target worker node may be used to run the application(s) corresponding to the scheduling task.

In some embodiments, the second scheduler 214 may obtain a persistent volume claim (PVC) corresponding to the scheduling task. The PVC may refer to a claim for storage requirement(s). Exemplary storage requirements may include a required storage size, a required storage type, a required preference usage, or the like, or any combination thereof. The required preference usage may refer to a specific usage that a storage resource is specified by the user. In some embodiments, the storage requirement(s) may be represented by a key-value pair. For example, if the required storage size is 1 TeraByte (T), the required storage size may be represented by “Required Storage Size: 1T” in the PVC. As another example, if the required storage type is a hard disk drive (HHD) storage resource or a solid state drive (SSD) storage resource, the required storage type may be represented by “Required Storage Type: HHD” or “Required Storage Type: SSD” in the PVC.

In some embodiments, for each of the one or more candidate worker nodes, the second scheduler 214 may obtain an annotation of the candidate worker node. The annotation of a candidate worker node may be used to store storage planning information relating to the storage resources in the candidate worker node. For example, the second scheduler 214 may obtain the annotation 226 relating to the storage resource 222 in the worker node 220 and the annotation 246 relating to the storage resource 241 and the storage resource 242 in the worker node 240. The storage planning information relating to the storage resources in the candidate worker node may include a storage identity, a storage size, an available storage size, a storage type, preference information, or the like, or any combination thereof, of each storage resource in the candidate worker node. In some embodiments, the storage planning information relating to the storage resources in the candidate worker node may be generated based on a storage planning instruction input by the user, and stored in the annotation of the candidate worker node. More descriptions the generation and/or storage of the storage planning information may be found elsewhere in the present disclosure (e.g., FIG. 5 and the descriptions thereof).

In some embodiments, the second scheduler 214 may select, from the one or more candidate worker nodes, at least one candidate worker node whose storage planning information in its annotation satisfies a condition defined in the PVC. The condition defined in the PVC may relate to, for example, the required storage size, the required storage type, the required preference usage, etc. If storage planning information in an annotation of a candidate worker node satisfies the condition defined in the PVC, the second scheduler 214 may determine the candidate worker node as one of the at least one selected candidate worker node. For instance, if an available storage size of a storage resource of a candidate worker node is larger the required storage size, the candidate worker node may be selected as one of the at least one candidate worker node.

In some embodiments, the second scheduler 214 may determine the target worker node from the at least one selected candidate worker node. For example, the second scheduler 214 may randomly select a candidate worker node from the at least one selected candidate worker node, and designate the candidate worker node as the target worker node. As another example, the second scheduler 214 may determine a score of each of the at least one selected candidate worker node based on its computing resources and storage resources, and designate a candidate worker node with a highest score among the at least one selected candidate worker node as the target worker node. The score may be determined based on a scoring rule or a scoring model (e.g., a trained machine learning model). Further, if there are a plurality of candidate worker nodes with the highest score, the second scheduler 214 may randomly select one candidate worker node from the plurality of candidate worker nodes with the highest score, and designate the candidate worker node as the target worker node.

In some embodiments, once the second scheduler 214 determines one candidate worker node whose storage planning information satisfies the condition defined in the PVC, the second scheduler 214 may determine the candidate worker node as the target worker node. Therefore, a workload of the second scheduler 214 may be reduced, which may reduce a time for determining the target worker node, and improve an efficiency of the resource management.

In 408, the second scheduler 214 (e.g., the scheduling module 320) may schedule at least part of the storage resources of the target worker node for the scheduling task.

In some embodiments, the second scheduler 214 may schedule the at least part of the storage resources of the target worker node for the scheduling task based on a scheduling algorithm. Exemplary scheduling algorithms may include a first come first serve (FCFS) algorithm, a round robin (RR) algorithm, a multi-level feedback round robin algorithm, a priority scheduling algorithm, a shortest-job first (SJF) algorithm, a highest response ratio next (HRRN) algorithm, or the like, or any combination thereof.

In some embodiments, the second scheduler 214 may generate a scheduling record recording that the at least part of the storage resources of the target worker node is scheduled for the scheduling task. In some embodiments, the second scheduler 214 may persistently store the scheduling record in a storage device (e.g., the storage device 216). For example, the second scheduler 214 may persistently store the scheduling record in an etcd component of the storage device.

In some embodiments, after the scheduling record is persistently stored in the storage device, a container storage interface (CSI) corresponding to the target worker node may establish a persistent volume (PV) for the scheduling task on the storage resources of the candidate worker node. More descriptions regarding the establishment of the PV may be found elsewhere in the present disclosure (e.g., FIG. 6 and the descriptions thereof).

In 410, the second scheduler 214 (e.g., the removal module 330) may remove, from the storage device, the scheduling record recording that the at least part of the storage resources of the target worker node is scheduled for the scheduling task.

In some embodiments, the second scheduler 214 may determine whether the PV has been established. For example, the second scheduler 214 may determine whether the PV has been established in a polling manner. As another example, the second scheduler 214 may obtain information transmitted from the target worker node (e.g., the CSI corresponding to the target worker node), the information may indicate whether the PV has been established.

In some embodiments, in response to determining that the PV has been established, the second scheduler 214 may remove the scheduling record from the storage device. Therefore, a storage amount in the storage device may be reduced, which can save a storage space of the storage device, and reduce a workload during the process of obtaining the scheduling record, thereby improving the efficiency of the resource management.

Some embodiments of the present disclosure, the second scheduler may be configured to schedule the at least part of the storage resources of the one or more candidate worker nodes for the scheduling task, which can improve management capability of the resource management system. Further, the PVC corresponding to the scheduling task may be obtained, and the target worker node may be determined based on the PVC and the storage planning information, which can improve an efficiency and an accuracy of the resource management. For example, a user may input a storage planning instruction according to his/her preference or need, and the storage planning information may be determined based on the storage planning instruction. By matching the storage planning information of each candidate worker node and the condition specified in PVC, a target worker node that matches the user's preference and meets the user's need may be determined.

It should be noted that the description of the process 400 is provided for the purposes of illustration, and is not intended to limit the scope of the present disclosure. For persons having ordinary skills in the art, various variations and modifications may be conducted under the teaching of the present disclosure. However, those variations and modifications may not depart from the protection of the present disclosure. For example, operation 404 may be performed before operation 402. Alternatively, operations 402 and 404 may be performed simultaneously. As another example, the storage planning information relating to the storage resources in each candidate worker node may be generated and stored before operation 402. As still another example, operation 410 may be omitted. That is, the scheduling record may be stored in the storage device after the PV is established.

FIG. 5 is a flowchart illustrating an exemplary process 500 for storing storage planning information in an annotation of a candidate worker node according to some embodiments of the present disclosure. In some embodiments, the process 500 may be implemented in the resource management system 200 illustrated in FIG. 2. For example, the process 500 may be stored in a storage device (e.g., the storage device 216, an external storage device) in the form of instructions (e.g., an application), and invoked and/or executed by a candidate worker node (or a processing device of the candidate worker node). The operations of the process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described is not intended to be limiting.

In 502, the candidate worker node may receive a storage planning instruction input by a user.

The storage planning instruction may refer to an instruction that is used to specific rules relating to the use of storage resources in the candidate worker node. For example, the storage planning instruction may specify which storage resource of the candidate worker node can be used, how much storage space of the candidate worker node can be used, what the usage of the storage resources of the candidate worker node, or the like, or any combination thereof. Merely by way of example, if the user wants to specify that a storage resource in a candidate worker node can only be used for a specific application, the user may input a storage planning instruction including a custom label relating to the specific application.

In some embodiments, the user may input the storage planning instruction via a user interface and/or an input device. In some embodiments, after the user inputs the storage planning instruction, the candidate worker node may receive the storage planning instruction. For example, the user interface may transmit the storage planning instruction to the candidate worker node, and the candidate worker node may receive the storage planning instruction.

In 504, the candidate worker node may generate, based on the storage planning instruction, storage planning information relating to the storage resources in the candidate worker node.

In some embodiments, the candidate worker node may generate the storage planning information based on the storage planning instruction. For example, the candidate worker node may generate key-value pairs corresponding to the storage planning instruction. For example, if the user designates that a storage resource in a candidate worker node to be used for an application of “rabbitmq” through a storage planning instruction, the storage planning information relating to the storage resource may include a key-value pair of “rabbitmq: yes.”

The storage planning information of the candidate worker node may further include other information relating to the storage resources of the candidate worker node. For example, the storage planning information may include a storage identity, a storage size, an available storage size, an available state, a storage type, a storage path (or a storage address), a preference usage, or the like, or any combination thereof, of each storage resource in the candidate worker node. The storage identity may refer to an exclusive identity of the storage resource. The storage size may refer to a total storage size of the storage resource. The available storage size may refer to a remaining storage size that has not been occupied. The storage type may refer to a type of the storage resource. The available state may refer to a state whether the storage resource is available. Exemplary storage types may include a hard disk drive (HHD) storage resource, a solid state drive (SSD) storage resource, or the like, or any combination thereof. The storage path may refer to a path that is used to direct the storage resource. The preference usage may refer to a specific usage of the storage resource that can only be used for a specific application.

In 506, the candidate worker node may store the storage planning information in an annotation of the candidate worker node.

The annotation may refer to a component that stores storage planning information relating to the storage resources in the candidate worker node. For example, referring to FIG. 2, the second scheduler 214 may store the storage planning information relating to the storage resource 222 in the worker node 220 in the annotation 226.

According to some embodiments of the present disclosure, the storage planning information relating to the storage resources may be generated, which can plan the usage of the storage resources according to the preference of the user, thereby improving the accuracy of subsequent scheduling of storage resources based on the storage planning information.

It should be noted that the description of the process 500 is provided for the purposes of illustration, and is not intended to limit the scope of the present disclosure. For persons having ordinary skills in the art, various variations and modifications may be conducted under the teaching of the present disclosure. However, those variations and modifications may not depart from the protection of the present disclosure.

FIG. 6 is a flowchart illustrating another exemplary process 600 for establishing a persistent volume (PV) for a scheduling task according to some embodiments of the present disclosure. In some embodiments, the process 600 may be implemented in the resource management system 200 illustrated in FIG. 2. For example, the process 600 may be stored in a storage device (e.g., the storage device 216, an external storage device) in the form of instructions (e.g., an application), and invoked and/or executed by each CSI in the resource management system 200. The operations of the process 600 presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described is not intended to be limiting.

In 602, the CSI (e.g., the CSI 228 or the CSI 248) may determine, based on a scheduling record, whether a candidate worker node corresponding to the CSI is a target worker node.

The scheduling record may be used to record that at least part of storage resources of the target worker node is scheduled for a scheduling task.

In some embodiments, the CSI may determine whether the candidate worker node corresponding to the CSI is the target worker node based on a storage identity of a storage resource scheduled for the scheduling task based on the scheduling record. For example, if a storage identity of a storage resource in the candidate worker node is the same as the storage identity of the scheduled storage resource, the CSI may determine that the candidate worker node corresponding to the CSI is the target worker node (i.e., the candidate worker node the CSI belongs to is scheduled for the scheduling task). If the storage identity of the storage resource in the candidate worker node is different from the storage identity of the scheduled storage resource, the CSI may determine that the candidate worker node corresponding to the CSI is not the target worker node.

If the candidate worker node corresponding to the CSI is not the target worker node, the CSI may end the process 600.

If the candidate worker node corresponding to the CSI is the target worker node, the process 600 may proceed to operation 604.

In 604, the CSI (e.g., the CSI 228 or the CSI 248) may establish a PV for the scheduling task on the storage resources of the candidate worker node corresponding to the CIS.

The PV may refer to a volume that defines, based on a PVC, the storage resources. The PV may be used to process (e.g., store) or implement the scheduling task.

In some embodiments, the CSI may establish a plurality of candidate PVs with different parameters (e.g., a storage size, a storage type, a preference usage, etc.) on the storage resources. And then, the CSI may determine a target PV from the plurality of candidate PVs based on the PVC. For example, the CSI may determine the target PV based on a consistent degree between parameters of each of the plurality of candidate PVs and the PVC.

In some embodiments, the CSI may determine, based on the scheduling record, storage resources of the candidate worker node that are used to establish the PV. For example, the CSI may determine the at least part of storage resources that are recorded in the scheduling record to be used to establish the PV.

In some embodiments, the CSI may establish the PV for the scheduling task on the determined storage resource(s) of the candidate worker node corresponding to the CIS. For example, the CSI may establish, based on the PVC, the PV on the determined storage resource(s). For instance, the CSI may establish a directory for the scheduling task on the determined storage resource(s) of the candidate worker node corresponding to the CIS, update a portion of storage planning information (e.g., an available storage size of each of the determined storage resource(s)) of the candidate worker node corresponding to the CIS, and establish the PV for the scheduling task on the determined storage resources. In some embodiments, the PV may be established through a plug-in (e.g., a volume plug-in).

In some embodiments, the CSI may further determine whether the PV has been established. If the PV has been established, the CSI may output an instruction indicating that the PV has been established to a second scheduler (e.g., the second scheduler 214). Accordingly, the second scheduler may remove the scheduling record from a storage device (e.g., the storage device 216) that stores the scheduling record. If the PV has not been established, the CSI may output an instruction indicating that the PV has not been established and a next target worker node needs to be determined.

It should be noted that the description of the process 600 is provided for the purposes of illustration, and is not intended to limit the scope of the present disclosure. For persons having ordinary skills in the art, various variations and modifications may be conducted under the teaching of the present disclosure. However, those variations and modifications may not depart from the protection of the present disclosure.

FIG. 7 is a schematic diagram illustrating an exemplary electronic device 700 for resource management according to some embodiments of the present disclosure. In some embodiments, one or more components of the resource management system 100, such as the master node 110, a worker node 120, may be implemented on the electronic device 700 shown in FIG. 7.

As shown in FIG. 7, components of the electronic device 700 may include at least one processor 710, at least one storage device 720 storing instructions that can be executed by the at least one processor 710, a bus 730 configured to connect different components (including the at least one processor 710 and the at least one storage device 720).

The at least one processor 710 may implement a process for resource management by executing the instructions.

The at least one storage device 720 may include a readable medium in the form of volatile memory, such as, a random access memory (RAM) 721 and/or a cache memory 722. In some embodiments, the at least one storage device 720 may further include a read only memory (ROM) 723.

The at least one storage device 720 may also include a program/practical tool 725 including at least one set of program module 724. The program module 724 may include an operating system, one or more applications, other program modules, program data, or the like, or any combination thereof. In some embodiments, the program module 724 may be implemented under a network environment.

The bus 730 may include one or more types of bus structures. In some embodiments, the bus 730 may include a storage bus, a storage controller, a peripheral bus, a processor, a local bus, or the like, or any combination thereof.

The electronic device 700 may also communicate with one or more external devices 740 (e.g., a keyboard, a pointing device, etc.). In some embodiments, the electronic device 700 may also communicate with one or more devices that allow a user to interact with the electronic device 700, and/or communicate with any devices that allow one or more computing devices (e.g., a router, a modem, etc.) to interact with the electronic device 700. This communication may be performed via an input/output (I/O) interface 750. In addition, the electronic device 700 may also communicate with one or more networks (e.g., LAN, WAN, and/or public networks, such as the Internet) through a network adapter 760. As shown in FIG. 7, the network adapter 760 may communicate with other modules of the electronic device 700 through the bus 730. It should be understood that other hardware and/or software modules may be used in conjunction with the electronic device 700 (not shown in FIG. 7). The other hardware and/or software modules may include a micro-code, a device driver, a redundant processing unit, an external disk driver array, a RAID system, a tape driver, a data backup storage system, or the like, or any combination thereof.

In some embodiments, the electronic device 700 may further include a computer application. When the computer application is executed by a processor, methods for resource management disclosed in the present disclosure may be implemented.

In some embodiments, the computer application may be implemented in the form of one or more computer-readable storage media. Exemplary computer-readable storage media may include a system, a device, etc., using electricity, magnetism, photology, electromagnetism, infrared, semiconductor, or the like, or any combination thereof. For example, the computer-readable storage medium may include an electrical connection including one or more wires, a portable disk, a U disk, a mobile hard disk, a ROM, a RAM, an erasable programmable read-only memory (EPROM), a compact disk read only memory (CD-ROM), a magnetic disk, an optical disk, or the like, or any combination thereof.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A resource management system, comprising:
a plurality of worker nodes, wherein each of one or more candidate worker nodes of the plurality of worker nodes includes both computing resources and storage resources; and
a master node communicatively connected to the plurality of worker nodes, wherein
the master node includes a first scheduler and a second scheduler,
the first scheduler is configured to allocate at least part of the computing resources of the one or more candidate worker nodes for a scheduling task, and
the second scheduler is configured to schedule at least part of the storage resources of the one or more candidate worker nodes for the scheduling task.

2. The system of claim 1, wherein each of the one or more candidate worker nodes is configured to:
receive a storage planning instruction input by a user;
generate, based on the storage planning instruction, storage planning information relating to the storage resources in the candidate worker node; and
store the storage planning information in an annotation of the candidate worker node.

3. The system of claim 1, wherein to schedule at least part of the storage resources of the one or more worker nodes for the scheduling task, the second scheduler is configured to:
determine whether the implementation of the scheduling task needs storage resources;
in response to determining that the implementation of the scheduling task needs storage resources, determine the one or more candidate worker nodes from the plurality of worker nodes;
determine a target worker node from the one or more candidate worker nodes for the scheduling task; and
schedule at least part of the storage resources of the target worker node for the scheduling task.

4. The system of claim 3, wherein to determine a target worker node from the one or more candidate worker nodes for the scheduling task, the second scheduler is configured to:
obtain a persistent volume claim (PVC) corresponding to the scheduling task;
for each of the one or more candidate worker nodes, obtain an annotation of the candidate worker node;
select, from the one or more candidate worker nodes, at least one candidate worker node whose storage planning information in its annotation satisfies a condition defined in the PVC; and
determine the target worker node from the at least one selected candidate worker node.

5. The system of claim 3, wherein the master node further includes a storage device, wherein the second scheduler is further configured to:
generate a scheduling record recording that the at least part of the storage resources of the target worker node is scheduled for the scheduling task; and
persistently store the scheduling record in the storage device.

6. The system of claim 5, wherein each of the one or more candidate worker nodes comprises a container storage interface (CSI) configured to:
determine, based on the scheduling record, whether the candidate worker node corresponding to the CSI is the target worker node;
in response to determining that the candidate worker node corresponding to the CSI is the target worker node, establish a persistent volume (PV) for the scheduling task on the storage resources of the candidate worker node corresponding to the CIS.

7. The system of claim 6, wherein the second scheduler is further configured to:
in response to determining that the PV has been established, remove the scheduling record from the storage device.

8. The system of claim 1, wherein the storage resource includes at least one of a hard disk drive (HHD) storage resource or a solid state drive (SSD) storage resource.

9. The system of claim 1, wherein the second scheduler is embedded in the first scheduler using a plug-in.

10. The system of claim 1, wherein the plurality of worker nodes and the master node form a Kubernetes cluster.

11. A method implemented on a resource management system having at least one processor and at least one storage device, the resource management system including a plurality of worker nodes and a master node communicatively connected to the plurality of worker nodes, wherein each of one or more candidate worker nodes of the plurality of worker nodes includes both computing resources and storage resources, and the master node includes a first scheduler and a second scheduler, the method comprising:
allocating at least part of the computing resources of the one or more candidate worker nodes for a scheduling task; and
scheduling at least part of the storage resources of the one or more candidate worker nodes for the scheduling task.

12. The method of claim 11, further comprising:
for each of the one or more candidate worker nodes,
receiving a storage planning instruction input by a user;
generating, based on the storage planning instruction, storage planning information relating to the storage resources in the candidate worker node; and
storing the storage planning information in an annotation of the candidate worker node.

13. The method of claim 11, wherein the scheduling at least part of the storage resources of the one or more worker nodes for the scheduling task includes:
determining whether the implementation of the scheduling task needs storage resources;
in response to determining that the implementation of the scheduling task needs storage resources, determining the one or more candidate worker nodes from the plurality of worker nodes;
determining a target worker node from the one or more candidate worker nodes for the scheduling task; and
scheduling at least part of the storage resources of the target worker node for the scheduling task.

14. The method of claim 13, wherein the determining a target worker node from the one or more candidate worker nodes for the scheduling task includes:
obtaining a persistent volume claim (PVC) corresponding to the scheduling task;
for each of the one or more candidate worker nodes, obtaining an annotation of the candidate worker node;
selecting, from the one or more candidate worker nodes, at least one candidate worker node whose storage planning information in its annotation satisfies a condition defined in the PVC; and
determining the target worker node from the at least one selected candidate worker node.

15. The method of claim 13, wherein the master node further includes a storage device, wherein the method further includes:
generating a scheduling record recording that the at least part of the storage resources of the target worker node is scheduled for the scheduling task; and
persistently storing the scheduling record in the storage device.

16. The method of claim 15, wherein each of the one or more candidate worker nodes comprises a container storage interface (CSI), and the method further includes:
determining, based on the scheduling record, whether the candidate worker node corresponding to the CSI is the target worker node;
in response to determining that the candidate worker node corresponding to the CSI is the target worker node, establishing a persistent volume (PV) for the scheduling task on the storage resources of the candidate worker node corresponding to the CIS.

17. The method of claim 16, further comprising:
in response to determining that the PV has been established, removing the scheduling record from the storage device.

18. The method of claim 11, wherein the second scheduler is embedded in the first scheduler using a plug-in.

19. The method of claim 11, wherein the plurality of worker nodes and the master node form a Kubernetes cluster.

20. A non-transitory computer readable medium in a resource management system including a plurality of worker nodes and a master node communicatively connected to the plurality of worker nodes, wherein each of one or more candidate worker nodes of the plurality of worker nodes includes both computing resources and storage resources, and the master node includes a first scheduler and a second scheduler, the non-transitory computer readable medium comprising executable instructions that, when executed by at least one processor, direct the at least one processor to perform a method, the method comprising:
allocating at least part of the computing resources of the one or more candidate worker nodes for a scheduling task; and
scheduling at least part of the storage resources of the one or more candidate worker nodes for the scheduling task.
